(19) United States
(12) Patent Application Publication
(10) Pub. No.: US 2020/0145220 A1
(43) Pub. Date: May 7, 2020

(54) VERIFICATION SYSTEM, VERIFICATION METHOD AND NON-TRANSITORY COMPUTER READABLE STORAGE MEDIUM

(71) Applicant: Chicony Electronics Co., Ltd., New Taipei City (TW)

(72) Inventor: Yu-Jen CHANG, New Taipei City (TW)

(21) Appl. No.: 16/502,040

(22) Filed: Jul. 3, 2019

(30) Foreign Application Priority Data
Nov. 1, 2018 (TW) 107138837

(51) Int. Cl. H04L 9/32; H04L 9/08; G06N 5/04; G06N 3/08; G06N 20/10

(52) U.S. Cl. CPC H04L 9/3231; H04L 9/3297; G06N 20/10; G06N 5/04; G06N 3/08; H04L 9/0844

(57) ABSTRACT

The present disclosure provides a verification system. The verification system includes a biometric extracting device and a recognition device. A first processor of the biometric extracting device is configured to generate a first confirming data and generate an encrypted biometric data by encrypting a biometric data based on the first confirming data. A second processor of the recognition device is configured to generate a second confirming data and generate a recognition result of likelihood vector data based on the encrypted biometric data, and encrypt the recognition result of likelihood vector data by using the second confirming data. The first processor uses the first confirming data to decrypt the recognition result of likelihood vector data, and determines whether to generate an instruction according to a decrypted result.

### CROSS-REFERENCE TO RELATED APPLICATION

This application claims priority to Taiwan Application Serial Number 107138837, filed on Nov. 1, 2018, which is herein incorporated by reference.

### BACKGROUND

### Field of Disclosure

The disclosure relates to a system and a method. More particularly, the disclosure relates to a verification system and a verification method. The disclosure is not limited to perform the transaction procedures at offline mode during the authentication period, but also at online mode.

### Description of Related Art

In network environment, systems usually need to authenticate user's identification. If the user wants to log in the operating platform, the user has to input login name for the user's account and the corresponding password to be verified. In some systems, they apply the biometric data to perform verifications. For example, the user has to register the biometric data. In subsequent authentication, the user can enter the login name and password along with biometric data to ensure that the user attempting to enter the operating environment is not an illegal intruder.

If the biometric data is used in the system to authenticate users, it is necessary to store the biometric data for all users on the remote server. However, the approach of storing the biometric data could result in a target of potential attacks. Therefore, it is necessary to propose an effective approach that can preserve biometric data integrity and achieve the identity verification.

### SUMMARY

The disclosure provides a verification system. The verification system comprises a bio-data capturing device and an identification device. The bio-data capturing device comprises a bio-data capturing circuit, a first communication interface, and a first processor. The bio-data capturing circuit is configured to capture a biometric data. The first processor is coupled to the bio-data capturing circuit and the first communication interface and configured to encrypt the biometric data according to a first authentication data to generate an encrypted bio-data. The identification device comprises a second communication interface and a second processor. The second communication interface is communicatively connected with the first communication interface and configured to receive the encrypted bio-data. The second processor is coupled to the second communication interface and configured to generate a recognition result of likelihood vector according to the encrypted bio-data, and to encrypt the recognition result of likelihood vector by using the second authentication data. The first processor decrypts the recognition result of likelihood vector which is encrypted by using the first authentication data and determines whether to generate an instruction according to the decrypted result.

The disclosure also provides a verification method, suitable for a verification system, wherein the verification system comprises a bio-data capturing device and an identification device. The bio-data capturing device comprises a bio-data capturing circuit, a first processor coupled to the bio-data capturing circuit, and a first communication interface coupled to the bio-data capturing circuit and the first processor. The identification device comprises a second processor and a second communication interface coupled to the second processor, wherein the second communication interface communicatively connected to the first communication interface. The verification method comprises: capturing, by the bio-data capturing circuit, a biometric data; encrypting, by the first processor, the biometric data to generate an encrypted bio-data according to a first authentication data; transmitting, through the first communication interface, the encrypted bio-data to the second communication interface; generating, by the second processor, a recognition result of likelihood vector according to the encrypted bio-data; encrypting, by the second processor, the recognition result of likelihood vector by using a second authentication data; and decrypting, by the first processor, the encrypted recognition result of likelihood vector, by using the first authentication data to determine whether to generate an instruction or not according to a decrypted result.

The disclosure also provides a non-transitory computer readable storage medium comprising programs stored thereon. While the programs are loaded into a first processor of a bio-data capturing device and a second processor of an identification device, the programs cause the first processor and the second processor to: capture a biometric data by a bio-data capturing circuit of the bio-data capturing device; encrypt, by the first processor, the biometric data to generate an encrypted bio-data according to a first authentication data; transmit the encrypted bio-data to the second communication interface; generate a recognition result of likelihood vector according to the encrypted bio-data; encrypt, by the second processor, the recognition result of likelihood vector by using a second authentication data; and decrypt, by the first processor, the encrypted recognition result of likelihood vector by using the first authentication data to determine whether an instruction should be generated according to a decrypted result.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a verification system according to an embodiment of this disclosure.

FIG. 2A and FIG. 2B are flow charts for transmission of data packets and data verifications illustrating in the verification system in FIG. 1 according to an embodiment of the disclosure.

FIG. 3 is a schematic diagram illustrating the verification system according to an embodiment of this disclosure.

FIG. 4A and FIG. 4B are flow charts for transmission of data packets and data verifications illustrating in the verification system in FIG. 3 according to an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

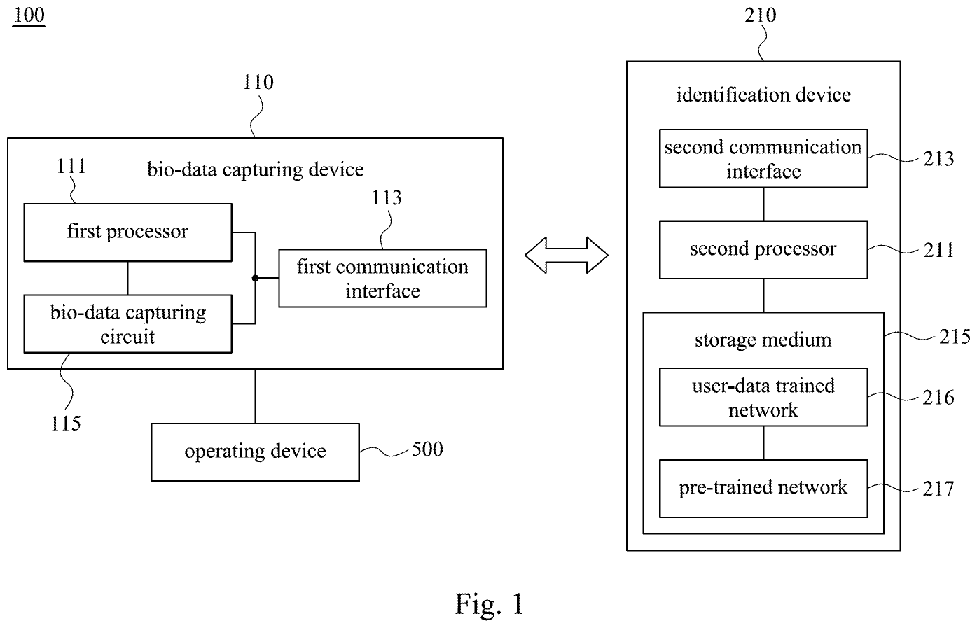

Please refer to FIG. 1. FIG. 1 is a schematic diagram illustrating a verification system 100 according to an embodiment of this disclosure. As shown in FIG. 1, the verification system 100 includes a bio-data capturing device 110 and an identification device 210. The bio-data capturing device 110 includes a first processor 111, a first communication interface 113, and a bio-data capturing circuit 115. The first processor 111 is coupled to the first communication interface 113 and the bio-data capturing circuit 115.

The bio-data capturing circuit 115 is configured to capture user's biometric data. In one embodiment, the bio-data capturing circuit 115 can be but not limited to circuit or module configured to capture the user's unique biological features, such as fingerprint features, iris features, etc.

The identification device 210 includes a second processor 211, a second communication interface 213, and a storage medium 215. The second processor 211 is coupled to the second communication interface 213. The second communication interface 213 communicatively connected with the first communication interface 113. For example, a first communication link between the first communication interface 113 and the second communication interface 213 can be constructed. The identification device 210 can exchange data, through the second communication interface 213, with the bio-data capturing device 110 selectively. The storage medium 215 includes user-data trained network algorithm 216 and pre-trained network algorithm 217, which will be stated as follows.

An operating device 500 is the device electrically connected with the bio-data capturing device 111. In one embodiment, the bio-data capturing device 110 will transmit instructions to the operating device 500 after confirming that the captured biological data matches the biological data of the person itself. In one embodiment, the operating device 500 starts its functions or other related operations after receiving instructions.

In one embodiment, the bio-data capturing device 110 can be but not limited to a fingerprint identification device disposed on cars to authenticate whether the user in car is the owner of the car or the authorized person. The operating device 500 is, for example, the electronic control unit (ECU) which controls functions of transportation equipments such as vehicles, automobiles and so on.

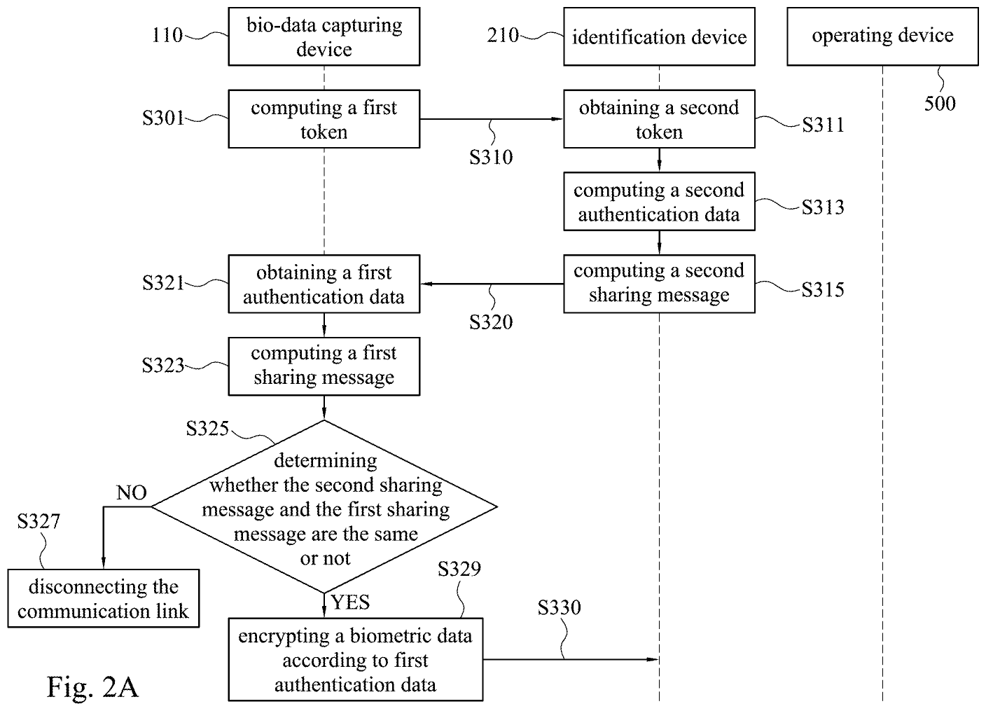

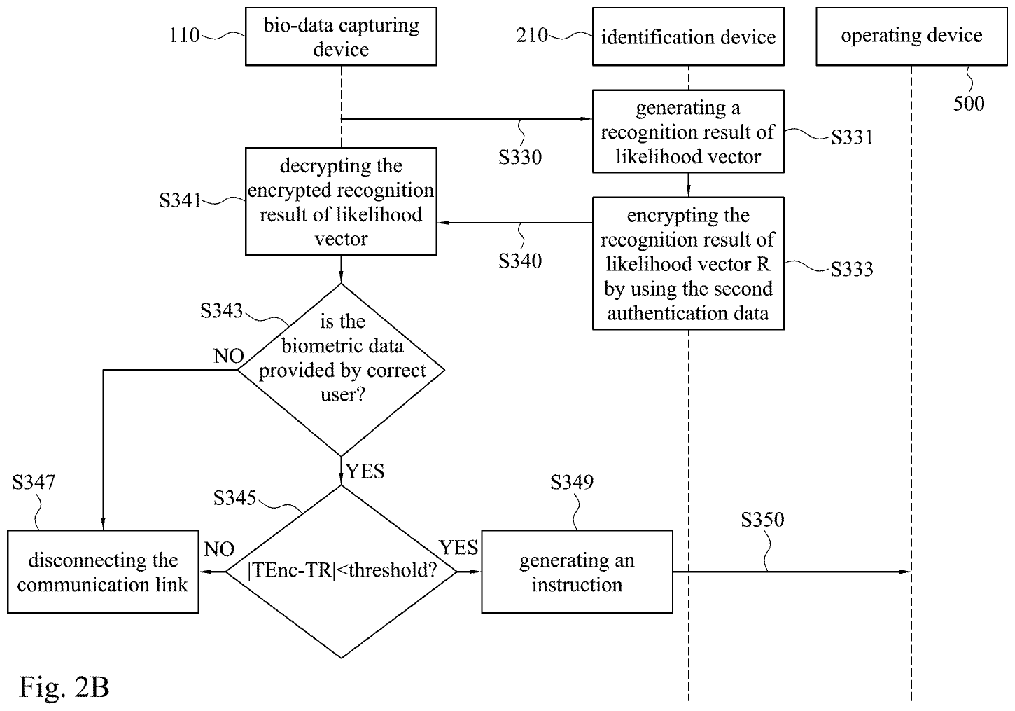

To illustrate details of the verification system and the verification method in the present disclosure, incorporating the flow charts of FIG. 2A and FIG. 2B. Further, person having ordinary skill in the art should understand that the verification method does not be limited in the verification system 100 of FIG. 1 and in the steps/proper orders of FIG. 2A and FIG. 2B. Please refer to FIG. 2A. FIG. 2A is the flow chart for transmission of data packets and data verifications illustrating in the verification system in FIG. 1 according to an embodiment of the disclosure. Please incorporate FIG. 1, as shown in FIG. 2A, in step S301, there is a first secret message x (secret x) stored in the bio-data capturing device 110, which the first secret message x is a ransom number, for example. The first processor 111 computes a first token X according to first secret message x. The first token X is generated from a key exchange protocol and the first secret message x. The key exchange protocol can be but not limited to the following function: X=g^{x} mod p, where p is a prime number, and g is an integer and is a primitive root of p. The bio-data capturing device 110 and the identification device 210 both store the parameter p and g, to execute the procedure of data verifications. In one embodiment, the present disclosure does not limit to the parameter p and g of the above function. While parameters satisfy some specific rules or relations, for example, Diffie-Hellman protocol, Elliptic Curve EF protocol, Hyperelliptic Curves, and so on, the rules or relations can also be applied in the key exchange protocol of the present disclosure.

In step S310, the bio-data capturing device 110 encapsulates the first token X, a time stamp T_{S} for clock synchronizations, and a first signature s₁ in a packet, and transmits the packet through the first communication interface 113, where the packet format is, for example, X∥T_{S}∥s₁. The time stamp TS records the time that the bio-data capturing device 110 transmits the packet and the time stamp T_{S} can be used to synchronize the clock between two communication devices (such as the bio-data capturing device 110 and the identification device 210). The first signature s₁ can be used for identifying whether the packet is correct or not. It should be noted that the notation “∥” in the present disclosure means the linkage of data encapsulated in the packet. For example, the three data, the first token X, the time stamp T_{S}, and the first signature s₁, are cascaded in one data packet.

In step S311, the identification device 210 receives the packet through the second communication interface 213. The identification device 210 decapsulates the packet and confirms the received packet is not altered according to first signature S₁. The identification device 210 stores a second secret message y (secret y), which the second secret message y is, for example, a random number. The second processor 211 computes a second token Y (token Y) according to the second secret message y. The second token Y is obtained via the key exchange protocol and the second secret message y. The key exchange protocol can be but not limited to the function: Y=g^{y} mod p. In step S313, the second processor 211 computes a second authentication data S′ according to the first token X and the second secret message y. The second authentication data S′ can be obtained from but not limited to the function: S′=X^{y} mod p. In step S315, the second processor 211 computes a second sharing message sh′ according to the second authentication data S′. The second sharing message sh′ can be obtained from but not limited to the function: sh′=g^{S′}mod p.

In step S320, the identification device 210 encapsulates the second token Y, the second sharing message sh′, an exchange time stamp T_{EX}, and the second signature s₂ in a packet and transmits the packet, wherein the packet format is, for example, Y∥sh′∥T_{Ex}∥s₂. The exchange time stamp T_{EX} is used to indicate the current transmission time, and the second signature s₂ is configured to identify whether the packet is correct or not.

In step S321, the bio-data capturing device 110 receives packets through the first communication interface 113. The bio-data capturing device 110 decapsulates the packet, confirms whether the received packet is altered or not via the second signature s₂, and obtains the second token Y and the second sharing message sh′ of the identification device 210. The first processor 111 computes the first authentication data S according to the second token Y and the first secret message x. The first authentication data S can be obtained from but not limited to the function: S=Y^{x} mod p. In step S323, the first processor 111 computes a first sharing message sh according to the first authentication data S. The first sharing message sh can be obtained from but not limited to the function: sh=g^{S} mod p. Further, in step S325, the first processor 111 compares the second sharing message sh′ with the first sharing message sh to determine whether they are the same or not. In one embodiment, the bio-data capturing device 110 will not transmit the secret message x in the transmitted packet, but the bio-data capturing device 110 infers, by the key exchange protocol, whether the receiver knows the secret message or has the common secret message instead. Similarly, the identification device 210 will not transmit the secret message y in the transmitted packet, but the identification device 210 infers, by the key exchange protocol, whether the receiver knows the secret message or has the common secret message. Hence, when the first sharing message sh and the second sharing message sh′ are different, in step S327, the bio-data capturing device 110 can determine that the identification device 210 does not know what the first secret message x is, that is, the second secret message y used by the identification device 210 is fake data or counterfeit data. Hence, the communication link (such as the first communication link) between the first communication interface 113 and the second communication interface 213 should be disconnected.

Usually, because biometric data can be intercepted or replaced by fake data without difficulty in transmission interfaces among the transmission process, such that the fake feedback authenticated message may be transmitted by the fake authentication node in the bio-data authentication process. Therefore, the bio-data capturing device 110 can determine whether the receiver knows the real secret message by the aforementioned method. If the receiver does not know the real secret message, the bio-data capturing device 110 can sift the adequate device from outer devices pretending to be the identification device 210.

In step S325, when the first sharing message sh and the second sharing message sh′ are the same, step S329 is proceeded. In step S329, the first processor 111 encrypts a biometric data Bio according to first authentication data S to generate an encrypted bio-data E(S,Bio). And, the first processor 111 generates an encrypted time stamp T_{Enc} corresponding to the encrypted bio-data E(S,Bio). On the other hand, the first processor 111 generates a hashed encrypted bio-data H(E(S,Bio) by computing the encrypted bio-data using Hash functions. Then, the first processor 111 generates a hash signature s₃₁ corresponding to the hashed encrypted bio-data H(E(S,Bio) and the encrypted time stamp T_{Enc}.

In step S330, the bio-data capturing device 110 encapsulates the hashed encrypted bio-data H(E(S,Bio), the encrypted time stamp T_{Enc}, the hash signature s₃₁, the encrypted bio-data E(S,Bio), and a third signature s₃₂ in a packet and transmits the packet, wherein the packet format is, for example, H(E(S,Bio))∥T_{Enc}∥s₃₁∥E(S,Bio)∥s₃₂. The third signature s₃₂ is configured to identify whether the packet is correct or not.

Please refer to FIG. 2B. FIG. 2B illustrates the flow chart for transmission of data packets and data verifications following FIG. 2A. Please incorporate FIG. 1 and FIG. 2A, as shown in FIG. 2B, in step S331, the identification device 210 receives the packet through the second communication interface 213. The identification device 210 decapsulates the packet, confirms that the packet is not altered by the third signature s₃₂ and obtains the encrypted bio-data E(S,Bio). The second processor 211 decrypts the encrypted bio-data E(S,Bio) and obtains the decrypted bio-data Bio′ (i.e. the bio-data Bio′ of verifying user) according to the second authentication data S′.

Then, the second processor 211 computes the decrypted bio-data Bio′ by using an inference algorithm to generate a recognition result of likelihood vector R. For example, the second processor 211 reads the user-data trained network algorithm 216 and the pre-trained network algorithm 217 to analyze the decrypted bio-data Bio′ and obtains the recognition result of likelihood vector R. The recognition result of likelihood vector R records the result of the inference algorithm, and the result can be used to compute likelihood probability between the bio-data Bio and the bio-data Bio′ of verifying user. Then, the second processor 211 determines whether the likelihood probability is greater than a threshold or not. If the likelihood probability is greater than the threshold, it is determined that the bio-data is provided by an authorized person.

In one embodiment, the inference algorithm is, for example, the Backpropagation algorithm, the deep convolutional network (such as AlexNet), the Convolutional Neural Network (CNN) algorithm, etc. The user-data trained network algorithm 216 and the pre-trained network algorithm 217 are, for example, the support vector machine (SVM) algorithm, the neural network (NN) algorithm, or other machine learning algorithm. For example, the identification device 210 computes the biometric data of individual user at first by using the SVM algorithm or the NN algorithm to train the user-data trained network algorithm 216 and the pre-trained network algorithm 217. For example, the decrypted biometric data (such as the decrypted bio-data Bio′) is a vector data. The second processor 211 inputs the decrypted biometric data to the user-data trained network algorithm 216 or the pre-trained network algorithm 217 and outputs another vector data (i.e. the recognition result of likelihood vector R).

In one embodiment, the identification device 210 does not have to store biometric data of all users in advance, that is, the identification device 210 does not have to compare the decrypted biometric data with the pre-stored biometric data. The identification device 210 transmits the data to the bio-data capturing device 110 in order to make an estimate of the authenticity of the identification device 210. Specifically, in the process of identifying the biometric data, the identification device 210 decrypts the encrypted bio-data E(S,Bio) as described above. Therefore, if the packet is captured by a fake device and the fake device does not have the real authentication information for decryption, the fake device cannot get the real biometric data. On the other hand, even if the identification device 210 recovers or decrypts the biometric data, the recovered or decrypted biometric data will be a wrong biometric data. A recognition result of likelihood vector is generated after the decrypted biometric data is processed by the inference algorithm, and the generated recognition result of likelihood vector will be not corrected either. For example, when a third device (such as an attacker) transmits a forged packet and counterfeits the time stamp and the likelihood vector, the identification device 210 can determine whether the third device is true or not. Or, the identification device 210 can use a testing packet (such as a bogus bio pattern) to ascertain whether the third device is true or not and the user is authenticated one or not.

Next, in step 333, the second processor S211 encrypts the recognition result of likelihood vector R, by using the second authentication data S′, to obtain an encrypted recognition result of likelihood vector E(S′,R). At the same time, a discriminating time stamp TR corresponding to the encrypted recognition result of likelihood vector E(S′,R) is generated, wherein the discriminating time stamp T_{R} (the recognition time stamp) is configured to indicate the time point of encrypting the recognition result of likelihood vector R.

Then, in step S340, the identification device 210 encapsulates the encrypted recognition result of likelihood vector E(S′,R), the discriminating time stamp TR and a forth signature s₄ in a packet and transmits the packet, wherein the packet format is, for example, E(S′,R)∥T_{R}∥s₄. The fourth signature s₄ is configured to identify correctness of the packet.

In step S341, the bio-data capturing device 110 receives the packet through the first communication interface 113. The bio-data capturing device 110 decapsulates the packet, confirms whether the received packet is not altered by the fourth signature s₄, and obtains the encrypted recognition result of likelihood vector E(S′,R) and the discriminating time stamp T_{R}. Then, the first processor 111 decrypts the encrypted recognition result of likelihood vector E(S′,R) by using the first authentication data S and obtains a decrypted result. The decrypted result can be used to indicate whether the biometric data is provided by a correct (or authenticated) user. Then, in step S343, it is determined whether the biometric data is provided by a correct (or authenticated) user. If the decrypted result indicates that the biometric data is provided by a correct (or authenticated) user, step S345 is proceeded. In step S345, the first processor 111 computes a value of time difference between the encrypted time stamp T_{Enc} and the discriminating time stamp T_{R}, and determines whether the value of time difference is less than a threshold. If the first processor 111 determines that the value of time difference is less than or equal to the threshold, step S349 is proceeded. In step S349, the first processor 111 generates an instruction, and the instruction is configured to control the operating device 500. In one embodiment that the operating device 500 is the on-board unit or the driving control device of cars or transportation equipment, the instruction is to, for example, unlock the car door, start the engine, and so on, but in the present disclosure, it is not limited by the above instructions.

In step S343, if the decrypted result indicates that the biometric data is not provided by a correct user, step S347 is proceeded. In step S347, the first processor 111 controls the first communication interface 113 to disconnect communication link (such as the first communication link) between the first communication interface 113 and the second communication interface 213. In another exemplary example, the first processor 111 further generates a warning message to indicate that one user without authentications attempts to operate the operating device. Further, in the above step S345, if the first processor 111 determines that the value of time difference is greater than the threshold, step 347 is also proceeded. The communication link (such as the first communication link) between the first communication interface 113 and the second communication interface 213 is disconnected.

In step S350, after the first processor 111 determines that the instruction can be generated, the bio-data capturing device 110 encapsulates the first token X, the time stamp T_{S}, the first signature S₁, the second token Y, the second sharing message sh′, the exchange time stamp T_{EX}, the second signature s₂, the hashed encrypted bio-data H(E(S,Bio), the encrypted time stamp T_{Enc}, the hash signature s₃₁, the encrypted recognition result of likelihood vector E(S′,R), the discriminating time stamp T_{R}, and the fourth signature s₄ in a packet, and then transmits the packet to the operating device 500, wherein the packet format is, for example, X∥T_{S}∥s₁∥Y∥sh′∥T_{Ex}∥s₂∥H(E(S,Bio))∥T_{Enc}∥s₃₁∥E(S,Bio)∥s₃₂∥E(S′,R)∥T_{R}∥s₄. Therefore, the operating device 500 receives integrated authentication data and all the received data are not altered.

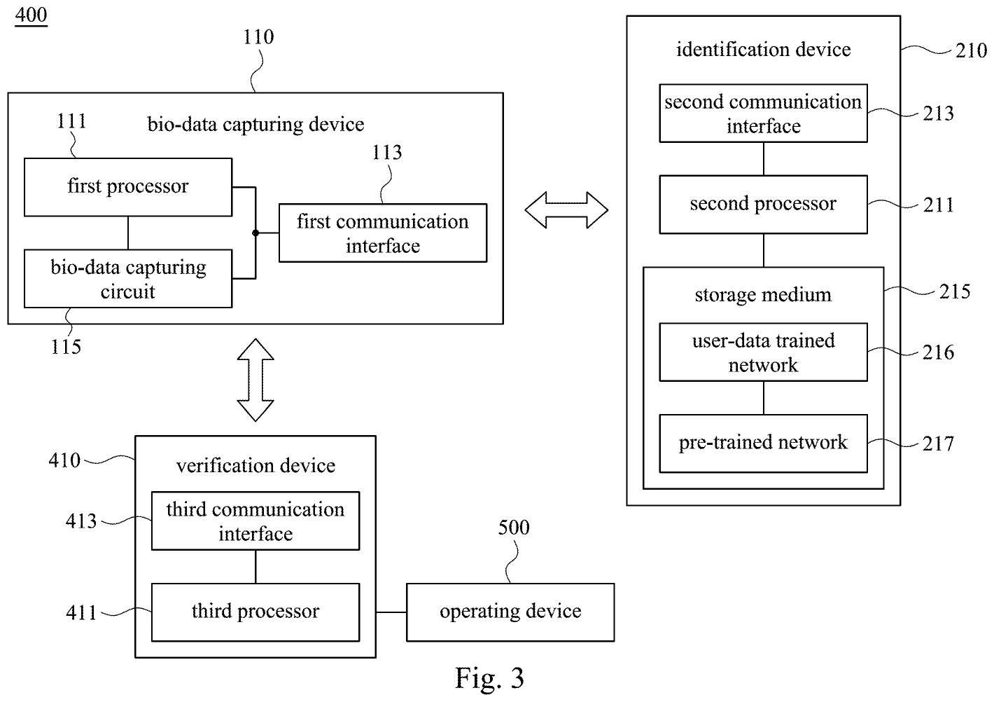

Below this section, another embodiment is provided with the signature that the biometric capturing device is not embedded in the verification device. Please refer to FIG. 3. FIG. 3 is a schematic diagram illustrating the verification system 400 according to an embodiment of this disclosure. As shown in FIG. 3, the verification system 400 comprises the bio-data capturing device 110, the identification device 210, and the verification device 410. The same elements in FIG. 3 are noted as the same notations in FIG. 1. Compared to FIG. 1, the operating device 500 in FIG. 3 is coupled to the verification device 410. Hence, in the exemplary example, the operating device 500 will receive the instructions from the verification device 410.

The verification device 410 comprises a third processor 411 and a third communication interface 413. The third processor 411 is coupled to the third communication interface 413. The verification device 410 communicatively connects with the bio-data capturing device 110 through the third communication interface 413 (for example, a second communication link between the first communication interface 113 and the third communication interface 413 can be established) and communicatively connects with the operating device 500.

In one embodiment, the bio-data capturing device 110 can be configured as, for example, polling booths disposed in different locations, and each of the polling booth has a fingerprint identification device to determine or verify whether voters are authenticated or not. The operating device 500 is, for example, the control center connecting to the polling booths, and configured to execute functions for any voting event. A secure tunnel can be established between the polling booths and the control center for communication, such as the virtual private network (VPN).

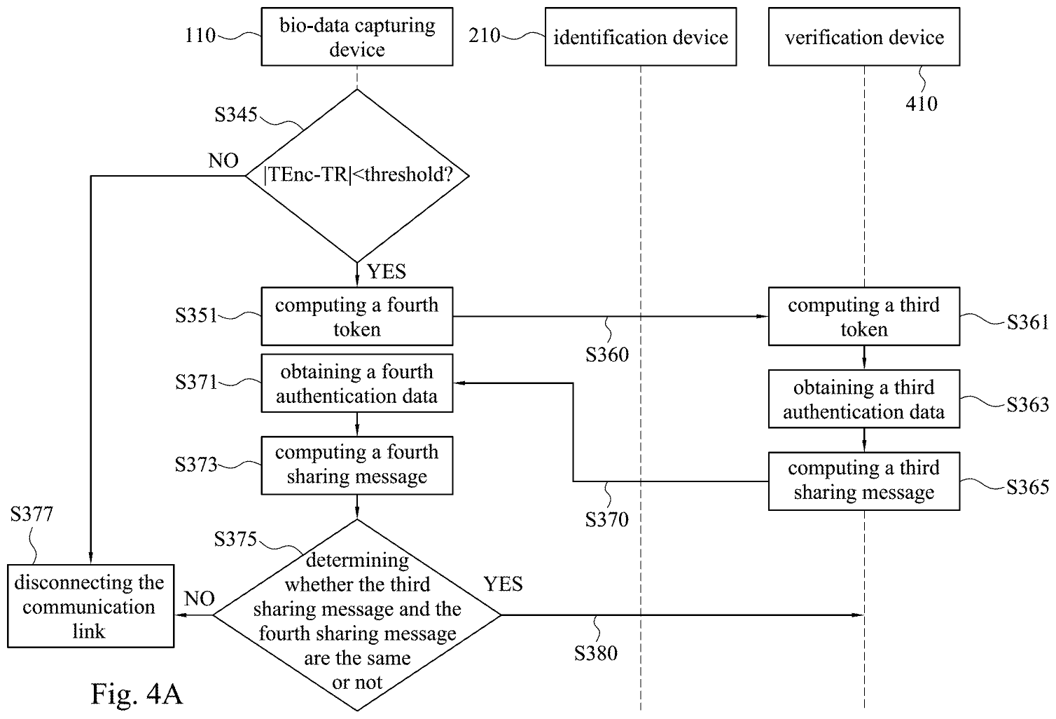

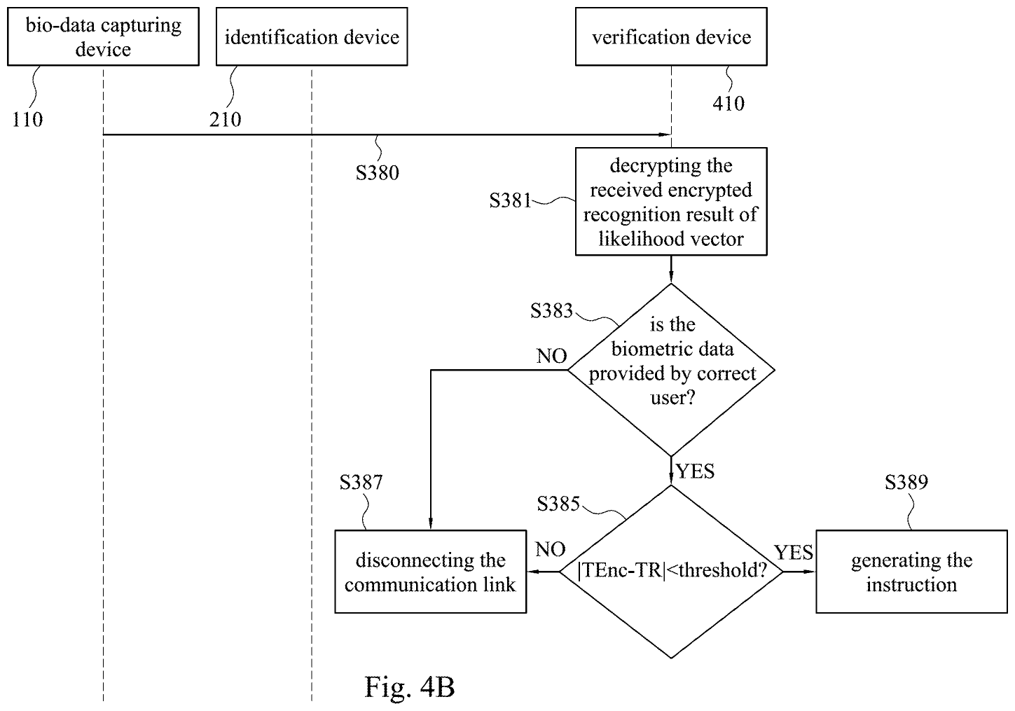

In order to clarify the operation of the above components and the verification method of the verification system, which is disclosed in the embodiment, the following will be paired with FIG. 4A and FIG. 4B. The flowchart for FIG. 4B is described in detail below. The person having ordinary skill in the art should understand the verification method of the present disclosure is not limited for applying the verification system 400 in FIG. 3 and the step orders of the flow charts of FIG. 4A and FIG. 4B. Please refer to FIG. 4A and FIG. 4B. FIG. 4A and FIG. 4B are flow charts for transmission of data packets and data verifications illustrating in the verification system 400 in FIG. 3 according to an embodiment of the disclosure. The exemplary examples in FIG. 4A and FIG. 4B follow step S343 of FIG. 2B.

As shown in FIG. 4A, in step S345, when the value of time difference between the encrypted time stamp T_{Enc} and the discriminating time stamp T_{R} is less than the threshold, step S351 is proceeded. In FIG. 3, after the bio-data capturing device 110 and the identification device 210 execute the verification method in FIG. 2A and FIG. 2B, because the operating device 500 in FIG. 3 is coupled to the verification device 410 (not as that the operating device 500 is coupled to the bio-data capturing device 110 shown in FIG. 1) and the bio-data capturing device 110 has to confirm whether the verification device 410 is a fake or invading device or not, the verification method in FIG. 4A and FIG. 4B should be proceeded to confirm that the verification device 410 is not an external intrusion device.

As shown in FIG. 4A, in step S351, the bio-data capturing device 110 computes the fourth token X′ (token X′), which is similar as above and not repeated in the paragraph. Then, in step S360, the bio-data capturing device 110 encapsulates the fourth token X′, a time stamp for clock synchronization Tᵣₑ₁, and a fifth signature sᵣₑ₁ in a packet and transmits the packet through the first communication interface, wherein the packet format is, for example, X′∥Tᵣₑ₁∥sᵣₑ₁. The time stamp Tᵣₑ₁ records the time that the bio-data capturing device 110 transmits the packet, and the time stamp Tᵣₑ₁ is configured to synchronize the clock between the two communication nodes (the bio-data capturing device 110 and the verification device 410). The fifth signature sᵣₑ₁ is used to identify the correctness of the packet.

In step S361, the verification device 410 receives the packet through the third communication interface 413. The verification device 410 decapsulates the packet and confirms that the received packet is not altered according to the fifth signature sᵣₑ₁. Then, the verification device 410 stores a third secret message z (secret z), and the third secret message z is a random number. The third processor 411 computes a third token Z (token Z) according to the third secret message z. The third token Z can be obtained through the key exchange protocol and the third secret message z. The key exchange protocol can be but not limited to the function: Z=g^{z} mod p. In step S363, the third processor 411 computes a third authentication data S″ according to the fourth token X′ and the third secret message z. The third authentication data S″ can be obtained from but not limited to the function: S″=X′^{z} mod p. In step S365, the third processor 411 computes a third sharing message sh″ according to the third authentication data S″. The third sharing message sh″ can be obtained from but not limited to the function: sh″=g^{S″} mod p.

In step S370, the verification device 410 encapsulates the third token Z, the third sharing message sh″, the exchange time stamp Tᵣₑ₂, and a sixth signature sᵣₑ₂ in a packet and transmits the packet, wherein the packet format is, for example, Z∥sh″∥Tᵣₑ₂∥sᵣₑ₂. The exchange time stamp Tᵣₑ₂ is configured to indicate the current transmitting time, and the sixth signature sᵣₑ₂ is used to identify the correctness of the packet.

In step S371, the bio-data capturing device 110 receives the packet through the first communication interface 113. The bio-data capturing device 110 decapsulates the packet, confirms that the received packet is not altered through the sixth signature sᵣₑ₂, and obtains the third token Z and the third sharing message sh″ of the verification device 410. Then, the first processor 111 computes a fourth authentication data S′″ according to the third token Z and the first secret message x. The fourth authentication data S′″ can be obtained from but not limited to the function: S′″=Z^{x} mod p. In step S373, the first processor 111 computes the fourth sharing message sh′″ according to the fourth authentication data S′″. The fourth sharing message sh′″ can be obtained from but not limited to the function: sh′″=g^{S′″} mod p.

Then, in step S375, the first processor 111 determines whether the third sharing message sh″ and the fourth sharing message sh′″ are the same or not. In one embodiment, the bio-data capturing device 110 and the verification device 410 will not transmits packets including their own secret message x and/or the secret message z to each other, instead, they infer whether the opposite side knows (or has) the secret message by using the key exchange protocol. Hence, when it is determined that the third sharing message sh″ and the fourth sharing message sh′″ are different, in step S377, the bio-data capturing device 110 infers that the verification device 410 does not know (have) the first secret message x, that is, third secret message z used by the verification device 410 is fake or counterfeited. Therefore, the communication link, such as the second communication link, between the first communication interface 113 and the third communication interface 413 is disconnected.

By the exemplary example method, the bio-data capturing device 110 can banish external device which pretends to be the verification device 410 from real devices to avoid other devices from counterfeiting the verification device 410 to attempt to connect with the bio-data capturing device 110. When it is determined that the third sharing message sh″ and the fourth sharing message sh′″ are the same in step S375, step S380 is proceeded.

Please refer to FIG. 4B. FIG. 4B is a flow chart illustrating the transmission of data packets and data verifications which follows that of FIG. 4A. In step S380, the bio-data capturing device 110 encapsulates the following data, the hashed encrypted bio-data H(E(S,Bio), the encrypted time stamp T_{Enc}, the hash signature s₃₁, the recognition result of likelihood vector E(S,R), the discriminating time stamp T_{R}, the fourth signature s₄, the encrypted recognition result of likelihood vector E(S′,R), and a seventh signature s₅ in a packet, and then transmits the packet to verification device 410. The packet format is, for example, H(E(S,Bio))∥T_{Enc}∥s₃₁∥E(S,R)∥T_{R}∥s₄∥E(S′,R)∥s₅. The seventh signature s₅ is configured to identify the correctness of the packet.

In step S381, the verification device 410 receives the packet through the third communication interface 413. The verification device 410 decapsulates the packet, confirms that the received packet is not altered via the seventh signature s₅, and obtains the encrypted recognition result of likelihood vector E(S′,R) and the discriminating time stamp T_{R}. Then, the third processor 411 decrypts the received encrypted recognition result of likelihood vector E(S′,R) by using the third authentication data S′″, and obtains a decrypted result. The decrypted result can be used to indicate whether the biometric data is provided by correct (authenticated) users. Then, in step S383, the third processor 411 determines whether the biometric data is provided by a correct user. Then, when the decrypted result indicates that the biometric data is provided by a correct user, step S385 is proceeded. In step S385, the third processor 411 computes a value of time difference between the encrypted time stamp T_{Enc} and the discriminating time stamp T_{R}, and determines whether the value of time difference is less than the threshold or not. When the third processor 311 determines that the value of time difference between the encrypted time stamp T_{Enc} and the discriminating time stamp T_{R} is less than or equal to the threshold, step S389 is proceeded. In step S389, the third processor 411 generates an instruction, and the instruction is for, for example, controlling the operating device 500.

When the decrypted result indicates that the biometric data is not provided by a correct user (the result in step S383 is ‘NO’), step S387 is proceeded. The third processor 411 disconnects the communication link between the third communication interface 413 and the first communication interface 113 (such as the second communication link). The third processor 411 generates a warning message to indicate that one user without authentications attempts to operate the operating device. On the other hand, in step S385, when the third processor 411 determines that the value of time difference between the encrypted time stamp T_{Enc} and the discriminating time stamp T_{R} is greater than the threshold, step S387 is also proceeded. The third processor 411 disconnects the communication link between the third communication interface 413 and the first communication interface 113 (such as the second communication link).

In one embodiment, the bio-data capturing device 110, the identification device 210, and the verification device 410 use Symmetric Encryption algorithm or Asymmetric Encryption algorithm in their communications.

In one embodiment, the signatures of the present disclosure can be generated by using Symmetric Encryption algorithm, Asymmetric Encryption algorithm, hash algorithm, and so on.

In one embodiment, the first processor 111, the second processor 211, and the third processor 311 can be but not limited to central processing unit (CPU), System on Chip (SoC), application processor, audio processor, digital signal processor, or other processing chip or controller with specific functions.

In one embodiment, the first communication interface 113, the second communication interface 213, and the third communication interface 413 can be but not limited to communication chips for Global System for Mobile communication (GSM), Long Term Evolution (LTE), worldwide interoperability for Microwave Access (WiMAX), Wireless Fidelity (Wi-Fi), Bluetooth technology and wired network.

In some exemplary examples, the verification method can be applied as computer programs and the programs can be stored in a non-transitory computer readable storage medium such that computers or electrical devices read the non-transitory computer readable storage medium to execute the verification method. The non-transitory computer readable storage medium can be but not limited to a read-only memory, flash memory, floppy disk, hard disk, optical disk, flash drive, a magnetic tape, network accessible database or other technologies, the person having ordinary skill in the art can think of the similar technology with the similar functions with the non-transitory computer readable storage medium.

As illustrated above, the verification system and the verification method of the present disclosure may or may not exchange public keys in advance according to the requirement of appliances, and the transmission node determines whether the opposite side node knows the secret by the shared message or not instead, in order to determine whether the opposite side node is a counterfeited device or not and whether the opposite side node is a phishing device or a malicious device. Furthermore, the biometric data does not be stored in the identification device in the present disclosure. The testing message is generated by pre-trained users' data to reduce the probability that the identification device is attacked because the identification device stores the original biometric data, and it is also difficult to reverse the pre-trained users' data into the users' original biometric data by the reverse engineering.

Further, in the present disclosure, the time of encrypting the original biometric data (i.e. the encrypted time stamp T_{Enc}) and the time of encrypting the recognition result of likelihood vector (i.e. the discriminating time stamp T_{R}) will be stored. By determining the value of time difference between them, when the value of time difference is too large, it represents that the devices might encounter the dictionary decryption (or violent decryption). Also, by recording the time stamp, the reasonable computing time can be estimated by hardware computation speed. Since the tokens are used for computation in the present disclosure and the potential malicious attacks need more computation time to get correct information, it is worth determining whether the value of time difference is greater than normal computation time, so that the man-in-the-middle attack can be detected.

In the present disclosure, in the verification system 400 of FIG. 3, it is confirmed that the data transmission between the bio-data capturing device 110 and the identification device 210 is not invaded and it is further confirmed whether the data transmission between the bio-data capturing device 110 and the verification device 410 is intruded. Therefore, the verification system 100, 400, and the verification method in the present disclosure can avoid from eavesdropping of external devices effectively.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A verification system, comprising:
a bio-data capturing device, comprising:
a bio-data capturing circuit configured to capture a biometric data;
a first communication interface; and
a first processor coupled to the bio-data capturing circuit and the first communication interface, wherein the first processor is configured to encrypt the biometric data to generate an encrypted bio-data according to a first authentication data; and
an identification device, comprising:
a second communication interface communicatively connected to the first communication interface, wherein the second communication interface is configured to receive the encrypted bio-data; and
a second processor coupled to the second communication interface, wherein the second processor is configured to generate a recognition result of likelihood vector according to the encrypted bio-data, and encrypt the recognition result of likelihood vector by using a second authentication data;
wherein the first processor decrypts the encrypted recognition result of likelihood vector by using the first authentication data, and determines whether to generate an instruction according to a decrypted result.

2. The verification system of claim 1, wherein the bio-data capturing device stores a first secret message, the first processor computes a first token by using the first secret message, and the first communication interface transmits the first token to the identification device.

3. The verification system of claim 2, wherein the identification device stores a second secret message, when the identification device receives the first token, the second processor is further configured to:
compute the second authentication data according to the first token and the second secret message;
compute, by using the second authentication data, a second sharing message according to a key exchange protocol;
compute a second token by using the second secret message; and
transmit, through the second communication interface, the second token and the second sharing message to the bio-data capturing device.

4. The verification system of claim 3, wherein when the bio-data capturing device receives the second token and the second sharing message, the first processor is further configured to compute the first authentication data according to the second token and the first secret message, and compute a first sharing message by using the first authentication data according to the key exchange protocol.

5. The verification system of claim 4, wherein the first processor is further configured to:
disconnect a first communication link between the first communication interface and the second communication interface while determining the first sharing message is different from the second sharing message; and
generate an encrypted time stamp corresponding to the encrypted bio-data, and transmit the encrypted bio-data and the encrypted time stamp to the identification device through the first communication interface while determining the first sharing message and the second sharing message are the same.

6. The verification system of claim 5, wherein the second processor is further configured to:
decrypt the encrypted bio-data according to the second authentication data, and compute by an inference algorithm, the encrypted bio-data which is decrypted to generate the recognition result of likelihood vector;
encrypt the recognition result of likelihood vector by using the second authentication data, and generate a discriminating time stamp corresponding to the encrypted recognition result of likelihood vector; and
transmit, through the second communication interface, the encrypted recognition result of likelihood vector and the discriminating time stamp to the bio-data capturing device.

7. The verification system of claim 6, wherein the first processor is further configured to determine whether to disconnect the first communication link between the first communication interface and the second communication interface according to the decrypted result.

8. The verification system of claim 6, wherein the first processor is further configured to:
compute a difference between the encrypted time stamp and the discriminating time stamp, and determine whether the difference is less than a threshold or not;
generate the instruction in condition that the difference is less than or equal to the threshold, wherein the instruction is configured to control an operating device; and
disconnect the first communication link between the first communication interface and the second communication interface in condition that the difference is greater than the threshold.

9. The verification system of claim 7, further comprising a verification device storing a third secret message, wherein the verification device comprises:
a third communication interface communicatively connected with the first communication interface to construct a second communication link with the first communication interface, wherein the third communication interface is configured to receive the first token of the bio-data capturing device;
a third processor coupled to the third communication interface, wherein the third processor is configured to:
generate a third authentication data according to the first token;
compute, by using the third authentication data, a third sharing message according to the key exchange protocol; and
compute a third token by using the third secret message;
wherein the third token and the third sharing message are transmitted to the bio-data capturing device through the third communication interface.

10. The verification system of claim 9, wherein the first processor is further configured to:
compute a fourth token by using the first secret message;
compute a fourth authentication data according to the fourth token and the third secret message;
compute, by using the fourth authentication data, a fourth sharing message according to the key exchange protocol; and
disconnect the first communication link between the first communication interface and the second communication interface and the second communication link between the first communication interface and the third communication interface in condition that the third sharing message and the fourth sharing message are different.

11. The verification system of claim 9, wherein the encrypted recognition result of likelihood vector, the encrypted time stamp, and the discriminating time stamp are transmitted through the first communication interface to the verification device.

12. The verification system of claim 11, wherein the third processor is further configured to decrypt the encrypted recognition result of likelihood vector according to the third authentication data, and to determine whether to generate the instruction according to a decrypted result, wherein the instruction is configured to control an operating device connected with the verification device.

13. The verification system of claim 11, wherein the third processor is further configured to:
compute a difference between the encrypted time stamp and the discriminating time stamp and determine whether the difference is less than a threshold or not;
generate the instruction in condition that the difference is less than or equal to the threshold, wherein the instruction is configured to control an operating device connected to the verification device; and
generate and transmit a warning message to the bio-data capturing device in condition that the difference is greater than the threshold.

14. A verification method, suitable for a verification system, wherein the verification system comprises a bio-data capturing device and an identification device, wherein the bio-data capturing device comprises a bio-data capturing circuit, a first processor coupled to the bio-data capturing circuit, and a first communication interface coupled to the bio-data capturing circuit and the first processor, wherein the identification device comprises a second processor and a second communication interface coupled to the second processor, wherein the second communication interface is communicatively connected to the first communication interface, wherein the verification method comprises:
capturing, by the bio-data capturing circuit, a biometric data;
encrypting, by the first processor, the biometric data to generate an encrypted bio-data according to a first authentication data;
transmitting, through the first communication interface, the encrypted bio-data to the second communication interface;
generating, by the second processor, a recognition result of likelihood vector according to the encrypted bio-data;
encrypting, by the second processor, the recognition result of likelihood vector by using a second authentication data; and
decrypt, by the first processor, the encrypted recognition result of likelihood vector by using the first authentication data to determine whether to generate an instruction or not according to a decrypted result.

15. The verification method of claim 14, wherein the bio-data capturing device stores a first secret message, the verification method further comprises:
computing a first token, by the first processor, by using the first secret message.

16. The verification method of claim 15, wherein the identification device stores a second secret message, the verification method further comprises proceeding the following steps when the identification device receives the first token:
computing a second token by using the second secret message;
computing the second authentication data according to the first token and the second secret message;
computing, by using the second authentication data, a second sharing message according to a key exchange protocol; and
transmitting, through the second communication interface, the second token and the second sharing message to the bio-data capturing device.

17. The verification method of claim 16, wherein the verification method further comprises:
computing, by the first processor, the first authentication data according to the second token and the first secret message when the bio-data capturing device receives the second token and the second sharing message; and
computing, by using the first authentication data, a first sharing message according to the key exchange protocol.

18. The verification method of claim 17, wherein the verification method further comprises:
disconnecting a first communication link between the first communication interface and the second communication interface in condition that the first sharing message is different from the second sharing message; and
generating an encrypted time stamp corresponding to the encrypted bio-data in condition that the first sharing message and the second sharing message are the same, and transmitting the encrypted bio-data and the encrypted time stamp to the identification device through the first communication interface.

19. The verification method of claim 18, wherein the verification method further comprises:
decrypting, by the second processor, the encrypted bio-data according to the second authentication data, and compute the encrypted bio-data which is decrypted by using an inference algorithm to generate the recognition result of likelihood vector;
encrypting, by the second processor, the recognition result of likelihood vector by using the second authentication data;
generating a discriminating time stamp corresponding to the encrypted recognition result of likelihood vector; and
transmitting, through the second communication interface, the encrypted recognition result of likelihood vector and the discriminating time stamp to the bio-data capturing device.

20. The verification method of claim 19, wherein the verification method further comprises:
determining, by the first processor, whether to disconnect the first communication link between the first communication interface and the second communication interface according to the decrypted result.

21. The verification method of claim 19, wherein the verification method further comprises:
computing, by the first processor, a difference between the encrypted time stamp and the discriminating time stamp, and determining whether the difference is less than a threshold or not;
generating, by the first processor, the instruction in condition that the difference is less than or equal to the threshold; and
disconnecting, by the first processor, the first communication link between the first communication interface and the second communication interface in condition that the difference is greater than the threshold.

22. The verification method of claim 20, wherein the verification system further comprises a verification device storing a third secret message, wherein the verification device comprises a third processor and a third communication interface, the third communication interface is coupled to the third processor and communicatively connected with the first communication interface to construct a second communication link, the verification method further comprising:
computing a fourth token by the first secret message;
receiving the fourth token through the third communication interface;
generating, by the third processor, a third authentication data according to the fourth token;
computing, by using the third authentication data, a third sharing message according to the key exchange protocol;
computing a third token by using the third secret message; and
transmitting, through the third communication interface, the third token and the third sharing message to the bio-data capturing device.

23. The verification method of claim 22, wherein the verification method further comprises:
computing, by the first processor, a fourth authentication data according to the fourth token and the third secret message;
computing, by the first processor, a fourth sharing message by using the fourth authentication data according to the key exchange protocol; and
disconnecting, respectively, the first communication link between the first communication interface and the second communication interface and the second communication link between the first communication interface and the third communication interface while determining, by the first processor, the third sharing message is different from the fourth sharing message.

24. The verification method of claim 22, wherein the verification method further comprises:
transmitting, through the first communication interface, the encrypted recognition result of likelihood vector, the encrypted time stamp, and the discriminating time stamp to the verification device while it is determined that the third sharing message and the fourth sharing message are the same.

25. The verification method of claim 24, wherein the verification method further comprises:
decrypting, by the third processor, the encrypted recognition result of likelihood vector according to the third authentication data, to determine whether to generate the instruction according to the decrypted result, wherein the instruction is configured to control an operating device connected with the verification device.

26. The verification method of claim 24, wherein the verification method further comprises:
computing a difference between the encrypted time stamp and the discriminating time stamp, and determining whether the difference is less than a threshold or not;
generating the instruction in condition that the difference is less than or equal to the threshold, wherein the instruction is configured to control an operating device connected with the verification device; and
disconnecting the first communication link between the first communication interface and the second communication interface in condition that the difference is greater than the threshold.

27. A non-transitory computer readable storage medium comprising programs stored thereon, while loading the programs into a first processor of the bio-data capturing device and a second processor of an identification device, causing the first processor and the second processor to:
capture a biometric data by a bio-data capturing circuit of the bio-data capturing device;
encrypt, by the first processor, the biometric data to generate an encrypted bio-data according to a first authentication data;
transmit the encrypted bio-data to a second communication interface of the identification device;
generate, by the first processor, a recognition result of likelihood vector according to the encrypted bio-data;
encrypt, by the second processor, the recognition result of likelihood vector by using a second authentication data; and
decrypt, by the first processor, the encrypted recognition result of likelihood vector by using the first authentication data to determine whether to generate an instruction or not according to a decrypted result.
